(19) United States
(12) Patent Application Publication
(10) Pub. No.: US 2002/0029229 A1
(43) Pub. Date: Mar. 7, 2002

(54) Systems and methods for data compression

(76) Inventors: David E. Jakopac, Elk Grove Village, IL (US); David W. Hurst, Chicago, IL (US); Veegee Murthy, Aurora, IL (US); Kevin Kail, Great Falls, VA (US)

Correspondence Address: NIXON PEABODY, LLP, 8180 GREENSBORO DRIVE, SUITE 800, MCLEAN, VA, 22102, US

(21) Appl. No.: 09/893,609

(22) Filed: Jun. 29, 2001

Related U.S. Application Data
(60) Provisional application No. 60/222,899, filed on Aug. 3, 2000.
(60) Provisional application No. 60/215,873, filed on Jun. 30, 2000.

(51) Int. Cl. G06F 17/00

(52) U.S. Cl. 707/500; 707/907

(57) ABSTRACT

A file is separated into three sections: a root, one or more fragments, and a fragment index. The root, which is uncompressed, maintains relationship information regarding fragments within the file. The fragments contain the actual data and are compressed, and the index, which is uncompressed, provides a list of all the fragments and, for example, an identification of any attributes associated with those fragments. Using this nomenclature, selective compression and decompression documents is possible.

### RELATED APPLICATION DATA

This application claims of benefit of U.S. Provisional Application Serial Nos. 60/222,899 entitled “Data Compression Scheme” filed Aug. 3, 2000 and 60/215,873 entitled “Commerce Software” filed Jun. 30, 2000.

### BACKGROUND OF THE INVENTION

1. Field of the Invention

This invention relates to data compression. In particular, this invention relates to selective compression and decompression of data.

2. Description of Related Art

Large files, such as extensible mark-up language (XML) files, e.g. documents, consume large amounts of storage and, by virtue of their size, take a considerable time to transmit over a distributed network, such as the Internet. For example, a product catalog represented in XML can consume a megabyte and, more commonly, might consume 10-100 megabytes of information. One obvious solution to reducing the size of the XML document is to compress the entirety of the file. For example, compression standards such as LZ77, as discussed in “A Universal Algorithm for Sequential Data Compression” by J. Ziv and A. Lempel, IEEE Transactions on Information Theory, Vol. 23, No. 3, WinZip® (www.winzip.com) and PKZIP® (www.pkware.com), incorporated herein by reference in their entirety, allow compression of an entire file. This speeds transmission over a network and further reduces the amount of storage space required to maintain the file.

### SUMMARY OF THE INVENTION

However, while the above compression techniques allow for increased transmission time and a reduced amount of storage space, they still require complete uncompression of the compressed file to view the information therein. The systems and methods of this invention overcome at least the above problems by allowing selective compression and decompression of information.

In particular, a file is separated into three sections: a root, one or more fragments, and a fragment index. The root, which is uncompressed, maintains relationship information regarding fragments within the file. The fragments contain the actual data and are compressed, and the index, which is uncompressed, provides a list of all the fragments and, for example, an identification of any attributes associated with those fragments.

Accordingly, in accordance with an exemplary embodiment of this invention, a first aspect of the invention relates to providing an improved data compression and decompression scheme.

Aspects of the invention also relate to providing selective compression of information.

Aspects of the invention also relate to providing selective decompression of information.

Aspects of the invention also relate to providing selective compression and decompression of XML documents.

Aspects of the invention also relate to providing selective compression based on a level parameter.

Aspects of the invention also relate to providing selective compression and decompression based on a document object model(DOM).

These and other features and advantages of this invention are described in, or are apparent from, the following detailed description of the embodiments.

### BRIEF DESCRIPTION OF THE DRAWINGS

The embodiments of the invention will be described in detail, with reference to the following figures wherein:

FIG. 1 illustrates an exemplary hierarchial file structure;

FIG. 2 graphically illustrates an exemplary method of compressing information according to this invention;

FIG. 3 graphically illustrates an exemplary method of compressing information according to this invention;

FIG. 4 graphically illustrates an exemplary method of compressing information according to this invention;

FIG. 5 graphically illustrates an exemplary method of compressing information according to this invention;

FIG. 6 graphically illustrates an exemplary method of compressing information according to this invention;

FIG. 7 graphically illustrates an exemplary method of compressing information according to this invention;

FIG. 8 graphically illustrates an exemplary method of decompressing information according to this invention;

FIG. 9 graphically illustrates an exemplary method of decompressing information according to this invention;

FIG. 10 graphically illustrates an exemplary method of decompressing information according to this invention;

FIG. 11 graphically illustrates an exemplary method of decompressing information according to this invention;

FIG. 12 illustrates an exemplary portion of an XML file;

FIG. 13 illustrates an exemplary XML file structure according to this invention;

FIG. 14 illustrates an exemplary portion of an XML file;

FIG. 15 illustrates an exemplary portion of an XML file;

FIG. 16 is a block diagram illustrating an exemplary compression/decompression system;

FIG. 17 is a flowchart illustrating an exemplary embodiment of compressing data according to this invention; and

FIG. 18 is a flowchart illustrating an exemplary method of decompressing data according to this invention.

### DETAILED DESCRIPTION OF THE INVENTION

For ease of illustration, the following description will be described in relation to the compression and decompression of an XML file. However, it should be appreciated, that the systems and methods of this invention can work with equal success on any type of stored electronic information.

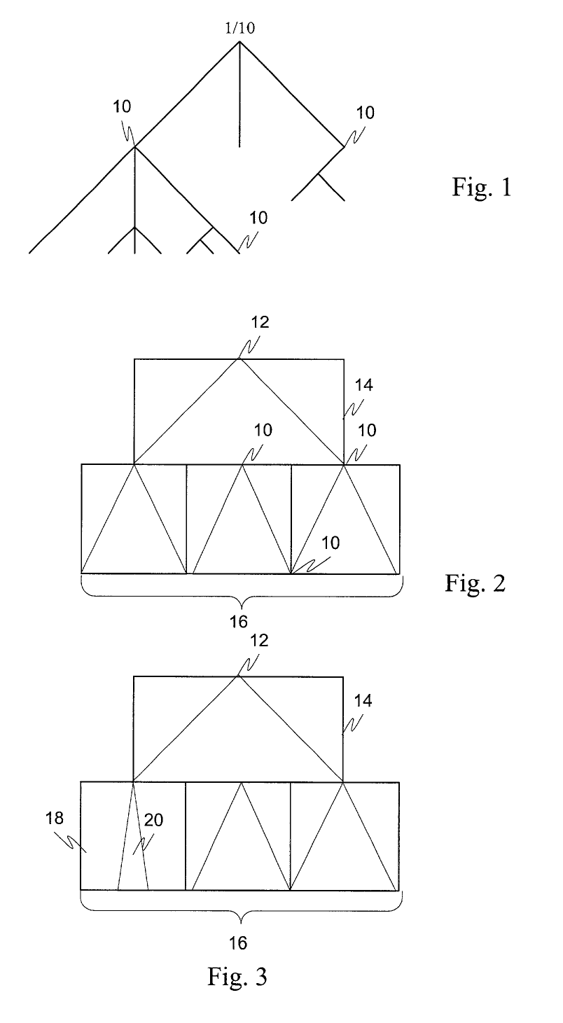

FIG. 1 illustrates an exemplary data structure of a document, such as, an XML or HTML document. The tree structure contains one or more nodes 10 linking the hierarchical portions of the file.

In the case of XML, documents are created by marking-up the original storage format of data. In particular, there are six kinds of mark-up that can occur in an XML document: elements, entity references, comments, processing instructions, marked sections and document-type declarations.

For a computer, such as a server, to serve an XML file to a client, the XML file must generally exist on a server. For example, the file can be stored on a hard drive, or may be constructed on the fly by one or more processes. Examples of such processes can be script-based processes that access a relational database and convert the contents of the relational database into an XML representation.

From the client, once the file has been received from the server, the file must be directly processed or stored on, for example, a hard drive. Typically, large XML files are not directly processed by a client due to, for example, processor burden.

Therefore, there are two application program interfaces (API) generally available to the client for reading and processing XML files, DOM and SAX. The document object model (DOM) API is a W3C recommendation and represents the XML document internally as a hierarchical representation, such as illustrated in FIG. 1. The DOM API requires that the document be read and a corresponding internal representation be built.

The SAX API is an ad hoc specification, which has not yet been officially recognized by a world-web standards organization. SAX provides an event driven interface where the client processes elements and entities in response to their being read by a SAX parser. SAX APIs are better suited to processing large XML files as long as the access needed by the client is sequential. In general, however, the DOM API does not have an advantage over the SAX API in that information about the XML document can be accessed at random locations in the document.

Based on this principle, the systems and methods of this invention can be integrated with the DOM API thereby, for example, providing client processes with random access to an original XML file without requiring the sequential processing of the SAX. Additionally, the output of the systems and methods of this invention can be directly created by, for example, a server-side process that constructs an XML document from one or more sources. If the data being represented in the XML file, or in general any file, has a natural, hierarchical characteristic, then the systems and methods of this invention can be utilized to create a file directly from the data source without having to create a temporary file, such as an XML file.

Given the exemplary hierarchical structure illustrated in FIG. 1, FIGS. 2-7 graphically illustrate the compression of a document according to an exemplary embodiment of this invention. In particular, FIG. 2 comprises a document root 12, a top of the tree portion 14, sub-tree portions 16 and one or more nodes 10. Therefore, FIG. 2 illustrates the various portions of a document, and how those portions are subdivided, prior to compression.

FIG. 3 illustrates the first step in selectively compressing the document. In particular, FIG. 3 comprises a sub-tree portion 18 that is undergoing compression according to AN exemplary embodiment of this invention. In particular, the sub-tree portion 18 comprises one or more individual entries, or fragments 20. In this exemplary embodiment, compression begins with the fragments 20. However, in general, compression can commence with any of the fragments located within any of the sub-trees 16.

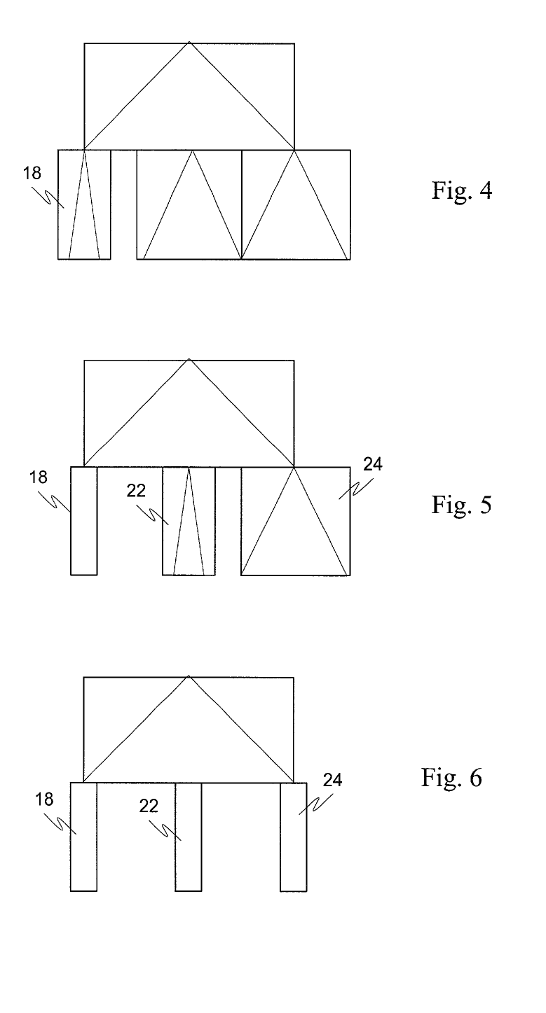

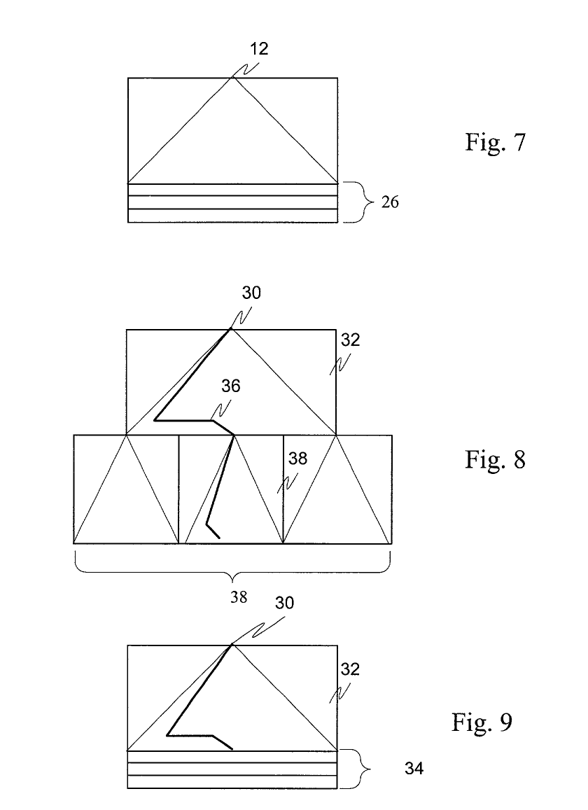

FIG. 4 illustrates that after completing compression of the fragments 20, the sub-tree 18 is itself compressed, while the document root and index, as discussed below, are updated. Then, in FIG. 5, after completion of compression of the sub-tree 18, the sub-trees 22 and 24, and fragments therein, are compressed. Compression continues in this manner until, as illustrated in FIG. 6, the sub-trees 18, 22 and 24 have been compressed. FIG. 7 illustrates an exemplary compressed document comprising the document root 12, and one or more compressed sub-trees 26.

FIG. 8 illustrates an exemplary desired traversal of a tree-structure for obtaining a portion of data from a document prior to compression of that document. In particular, the hierarchical document structure comprises a document root 30, a top of the tree portion 32, and a plurality of sub-trees 38. The traversal path 36 points to a particular fragment (not shown) that exists in the sub-tree 38.

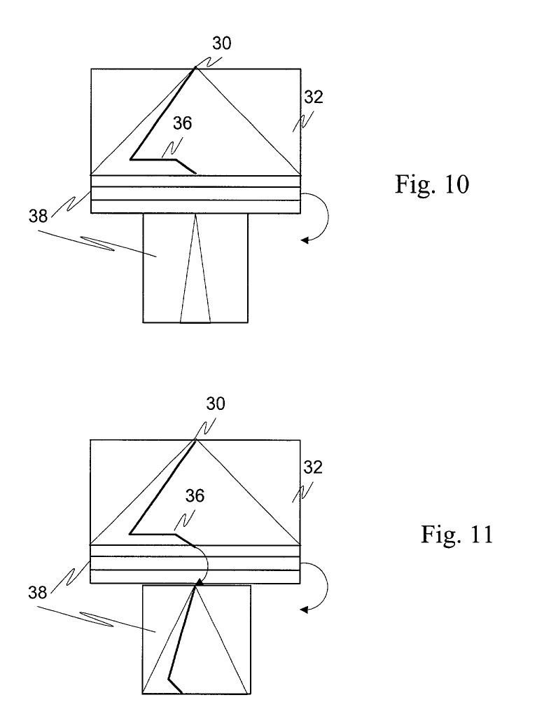

FIG. 9 illustrates the document of FIG. 8 in compressed format according to an exemplary embodiment of the systems and methods of this invention. Therefore, for selective decompression, the compression for the particular sub-tree and fragments is reversed. Specifically, FIG. 10 illustrates that upon selection of the traversal path to a particular fragment, the sub-tree including that fragment is uncompressed as sub-tree 38. The sub-tree 38 is uncompressed such that, as illustrated in FIG. 11, the traversal path 36 can be recreated, and will traverse down to the individual fragment(s) that requires decompression for viewing or other access. In this manner, only the actual fragment that needs to be accessed is uncompressed, leaving the remaining fragments and/or sub-trees in their original compressed format.

A compressed XML file according to the exemplary systems and methods of this invention has a structure similar to a ZIP file format. Specifically, like a ZIP file format, the initial bytes in the file are the ZIP header information. This file format is directly supported by the JAVA® ZIP package, and in particular, the ZIP input stream and ZIP output stream I/O classes. The first ZIP entry in the file is the XML document tree prefix. The tree prefix is the original XML file with selected sub-trees replaced with a single, empty tag. The sub-trees that are removed are all the sibling sub-trees at a particular level, as described above. The first entry is denoted in the compressed ZIP entry with a name ending in “.0.” The last ZIP entry in the compressed file is the index. The index lists all the compressed file entries in the identification attribute of the corresponding <xmlzip> tag. The index entry in the compressed file has a name ending in, for example, “.i.”

Both the tree prefix, i.e., the .0 entry and the index, i.e., the .i entry, are uncompressed for quick extraction. The remaining compressed entries in the compressed file are then compressed, or deflated, sub-tree fragments. Each entry has a name that ends in a dot followed by, for example, a number greater than zero.

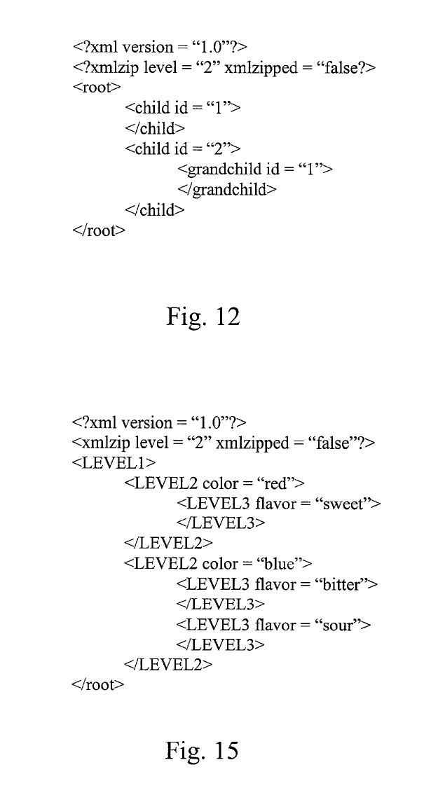

XML files are compressed according to an exemplary embodiment of this invention based on a level parameter. The level parameter specifies how many nested entity levels down from the document root to go before compressing sub-trees. For example, a LEVEL 2 XML compressed file has each child of the document root replaced with a reference, e.g., <child id>, to the compressed sub-tree. FIG. 12 illustrates an exemplary XML file. The XML entity tags, e.g., child id, grandchild id . . . , correspond to the relationship of the entity tag to the document tree structure.

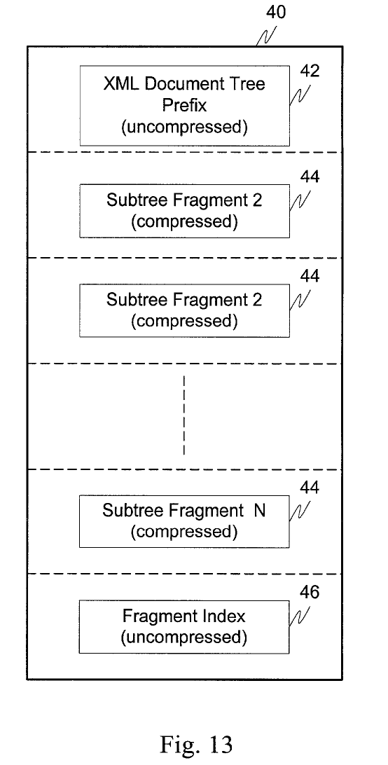

FIG. 13 illustrates an exemplary structure of a compressed file according to this invention. In particular, the exemplary compressed file is an XML file 40 that comprises a document tree 42, that is uncompressed, one or more sub-tree fragments 44 that are compressed, and a fragment index 46 that is uncompressed.

Prior to compression, according to an exemplary embodiment of this invention, an optional processing instruction, e.g, tag, can be inserted into either the non-XML or XML file for specifying the default level of compression. The processing instruction can also indicate if the document being compressed will be “XML compressed” according to the systems and methods of this invention.

An exemplary tag that can be used for the processing instructions is “xmlzip.” Associated with this exemplary tag are two attributes: LEVEL and xmlzip. The LEVEL attribute can, for example, take numeric values and indicate the default document tree level to commence compression of sub-trees. The xmlzip attribute can, for example, take the values “true” and “false.” If the xmlzip attribute is “false,” then the document has not been compressed according to the systems and methods of this invention. However, if the xmlzip attribute is “true,” then the document is compressed according to the systems and methods of this invention.

An example of a processing instruction that might occur in a non-compressed file can indicate, unless overridden, compression should occur for entity sub-trees that are nested three levels in from the root is:

<?xmlzip level=“3” xmlzipped=“false”?>

An example of a processing instruction that might occur in a compressed file that indicates that the default compression level is four can be written as:

<?xmlzip level=“4” xmlzipped=“true”?>

Note that the level does not indicate the level at which compression actually occurs. Rather, the level indicates the default level intended by, for example, an original author. While possible, it may not be desirable to use the level attribute to aid in decompression. Specifically, software that reads an xmlzip file should not assume that the level attribute corresponds to the level used to compress the file. To the contrary, the level attribute is intended to allow authors to indicate an optimal compression level, despite the level actually used. So, for example, an author may indicate that a catalog should be compressed at level 5 because all information below the tag level 5 contains information specific to a single product item. However, someone who redistributes the catalog may have chosen to force compression to occur at level 4 in the copy of the documented which they manage and/or distribute.

During compression, the xmlzip tag, e.g., <?xmlzip>, is inserted into the document root entry at locations where sub-trees have been deflated and moved to sub-tree entries. These processing instructions are used in the xmlzip format to maintain the relationship between the document tree and the sub-trees. When the processing instruction, e.g., tag, is used in this manner, the level in xmlzipped attributes do not need to be used.

An XML file compressed according to the systems and methods of this invention has three sections. The first section is a modified root entry, e.g., document tree, the second section the document sub-tree entries, and a third section, the index, as discussed above in relation to FIG. 13. The modified root entry 42 contains the original XML document, except that all nodes below a certain level in the document hierarchy are replaced with the:

<?xmlzip id=“1”/>

processing instruction. The document root entry 42 is the first entry in the XMLZIP file. It is stored uncompressed for quick access and parsing. The level at which sub-trees are replaced depends upon the level specified during compression. A default level can be specified in a processing instruction, e.g., <?xmlzip/>. Levels may also be specified, and override xmlzip processing instruction level attributes, by, for example, mechanisms present in an individual XML processor.

The xmlzip processing instruction xmlzipped attribute is set to “true” inside the first entry of an Xmlzipped file. For example, the program that generates the compressed file can modify the xmlzipped attribute and set it to “true.” Likewise, if the xmlzipped file is read and, for example, presented in uncompressed format to other software or written as an uncompressed file, the xmlzipped attribute should be returned to “false.”

The sub-trees that have been removed from the document root entry have individual entries in the next section of the xmlzip file. Each of these entries is a sub-tree fragment and contains a single sub-tree root, which is a copy of the parent node in the original document. This ensures that sub-tree entries are single roots and not forests.

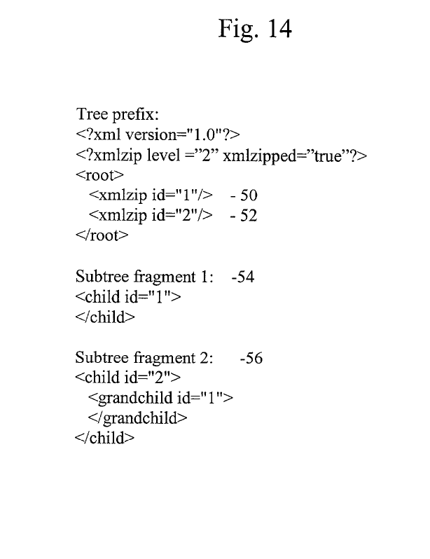

FIG. 14 illustrates an exemplary tree prefix for a LEVEL 2 tree and the corresponding fragments that have been replaced with the instructions 50 and 52 corresponding to the respective compressed sub-tree fragment 54 and 56, respectively.

For example, FIG. 15 illustrates an original document with entry tags LEVEL 1, LEVEL 2 and LEVEL 3. If compression is specified for LEVEL 2, there will be two sub-tree entries in the compressed file. The first entry will correspond to the LEVEL 2 entity with color attribute “red” and the second will be the LEVEL 2 entity with the color attribute “blue.”The LEVEL 2 tag is copied into the compressed sub-trees so that each is a proper tree and not a forest. If this were not done, the sub-tree for the LEVEL 2 entity with color attribute “blue” would have a single compressed file entry that contained two level 3 entities with no sub-tree root.

Therefore, each sub-tree entry is compressed using, for example, a deflation algorithm such as that used in the ZIP compression format, which is a variation of the Lempel-Ziv algorithm, or the like.

The final portion of the compressed file is an index table. The index table is not deflated, so that, for example, it can be quickly loaded. Each line in the sub-tree index entry contains a number and the name of a sub-tree entry. The index corresponds to the “id” attribute of the xmlzip tag. The index and the sub-tree entry name are separated by, for example, a white space.

For example, for the original document illustrated in FIG. 15, the sub-tree index would contain the following two entries:

LEVEL2.1

LEVEL2.2

Alternative approaches to the compression and decompression techniques of this invention are compression of the entire file, such as, in a ZIP or UNIX compressed format. These approaches will result in smaller files, but will require, for example, more time to compress. Furthermore, for large files where only a few sub-trees need to be accessed, or where only the top level document entity nodes need be accessed, the systems and methods of this invention will result in, for example, less time consumption to inflate and less memory to store the needed portion of the document tree.

Likewise, actual performance depends upon implementation. If an implementation uncompresses all sub-trees and inserts each sub-tree into the root document tree, then there will be no memory savings and a performance penalty over compressing and decompressing the entire file. However, the systems and methods of this invention provide for intelligent inflation, where only the sub-trees needed to respond to DOM calls are inflated. In cases where only the top levels of the document tree are accessed, no inflation will be needed despite the fact that much of the file is deflated.

For example, the systems and methods of this invention can be implemented based on the DOM that supports inflation of compressed files. The second and third applications of the systems and methods of this can use a dedicated xmlzip DOM. The second would read and XML file and write an xmlzip format file. Alternatively, the third could be a browser plug-in that reads an xmlzip format file and produces XML file that is passed to, for example, a browser.

For a DOM implementation that supports xmlzip, the Implementation could determine the file format upon opening the source file. After recognizing that the file is in xmlzip format, an internal representation based upon the modified root entry in the xmlzip file could be built. Thus, the XML tags would remain in the internal representation. When navigational routines require access to sub-trees of entries that contain processing instructions, such as <?xmlzip>, the xmlzip file entry would be looked-up in the index entry, read, inflated and added to the tree. Optionally, once a sub-tree is no longer used for processing a DOM request, it can be deleted and replaced with the original xmlzip tag, or, for example, cached and removed upon cache overflow with an algorithm such as a least recently used scheme.

Similarly, document trees created through the DOM can be written as xmlzip files if the document contains the <?xmlzip/> processing instruction. The processing instruction contains, for example, the xmlzip level specification needed to write the file in the appropriate format.

For example, an Internet web server can be used for serving XML files for clients that are xmlzip compatible. For example, if a client requests a URL to an xmlzip file, and only the uncompressed version of that file exists, the server can, for example, create an xmlzip file on the fly, and deliver it to the client. Alternatively, the compressed file can be created by a stand-alone implementation of the systems and methods of this invention.

Furthermore, conversion of the compressed file format back to the original format can be accomplished by an algorithm similar to that discussed above. An xmlzip compatible DOM implementation could open the xmlzip file, navigate through all nodes in the document tree and write out the corresponding nodes. Alternatively, the xmlzip processing instruction can be removed from the tree and a write of the tree to a file would be in the original document format. Such an application can be used by, foe example, a browser plug-in that reads the compressed file served by a web server and converts it to XML for use in the browser.

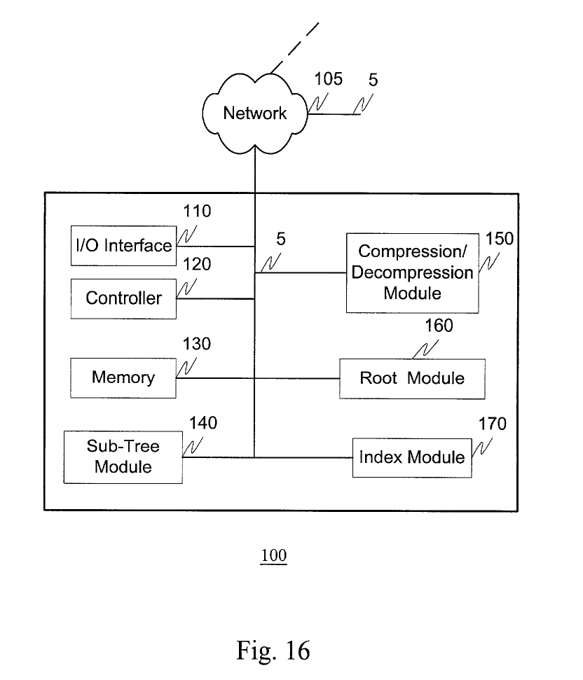

FIG. 16 illustrates an exemplary data compression/decompression system 100 according to an exemplary embodiment of this invention. In particular, the data compression/decompression system 100 comprises an I/O interface 110, a controller 120, a memory 130, a sub-tree module 140, a compression/decompression module 150, a root module 160 and an index module 170, all interconnected by links 5. Additionally, the data compression/decompression system 100 is connected to one or more distributed networks 105 that may be connected to, for example, additional data compression/decompression systems, clients, other computers, web browsers, or the like.

Furthermore, the links 5 can be a wired or wireless link or any known or later developed element(s) that is capable supplying and communicating electronic data to and from the connected elements. Additionally, the data compression/decompression system may be connected to one or more input devices (not shown) such as a keyboard, a mouse, a speech to text converter, or any other device capable of supplying information to the system. Furthermore, the data compression/decompression system may be connected to one or more display devices (not shown) that can be a computer monitor, a display on a PDA, or any other device capable of displaying information to one or more users.

While the exemplary embodiment illustrated in FIG. 16 shows the data compression/decompression system 100 and associated components collocated, it is to be appreciated that the various components of the data compression/decompression system 100 can be located at distant portions of a communications network. Thus, it should be appreciated that the components of the data compression/decompression system 100 can be combined into one device or separated into a plurality of devices. Furthermore, it should be appreciated that for ease of illustration, the various functional components of the data compression/decompression system 100 have been divided and illustrated in FIG. 16. However, any of the functional components illustrated in FIG. 16 can be combined or further partitioned without affecting the operation of the system. As will be appreciated from the following description, and for reasons of computational efficiency, the components of the system can be arranged in any location of a distributed network without effecting the operation of the system. Furthermore, it is to be appreciated that the term module as used herein includes any hardware and/or software that provides the functionality as discussed herein.

In operation, a file is received for compression, via, for example, the network 105 and link 5, and with the cooperation of the I/O interface 110, the controller 120, and the memory 130, evaluated by the root module 160. The root module 160, and in accordance with a level parameter, modifies the document root by replacing each child with a reference to the compressed sub-tree. For example, in LEVEL 2 compression, all children with a child id of two or greater are compressed and the document root replaced with a reference to the compressed sub-tree. Next, the sub-tree module 140, again in cooperation with the controller 120 and the memory 130, for each sub-tree that was removed from the document root entry by the root module 160, identifies the associated sub-tree fragment. In particular, the sub-trees that were removed from the document root entry have individual entries in the sub-tree fragment portion of the compressed file. Each of these entries is a sub-tree fragment and contains a single sub-tree root, which is a copy of the parent node in the original document. This ensures that sub-tree entries are single trees and not forests. The compression module 150 then compresses the sub-tree fragments, for example, using standard and well known compression techniques.

In parallel with, or subsequent to compression, the index module 170 determines a sub-tree index, that is in uncompressed form, and contains the number and the name of the sub-tree entries. The index generally corresponds to the “id” attribute of the XML tags.

For decompression, based on a data request, the root module 160 reads the root entry. Then, in cooperation with sub-tree module and the decompression module 150, the one or more requested sub-tree fragments are located and individually decompressed. The root module 160 can then optionally update root entry indicating that one or more sub-tree fragments have been uncompressed. The decompressed sub-tree fragments can then be output, with the cooperation of the I/O interface 110 and controller 120 via link 5.

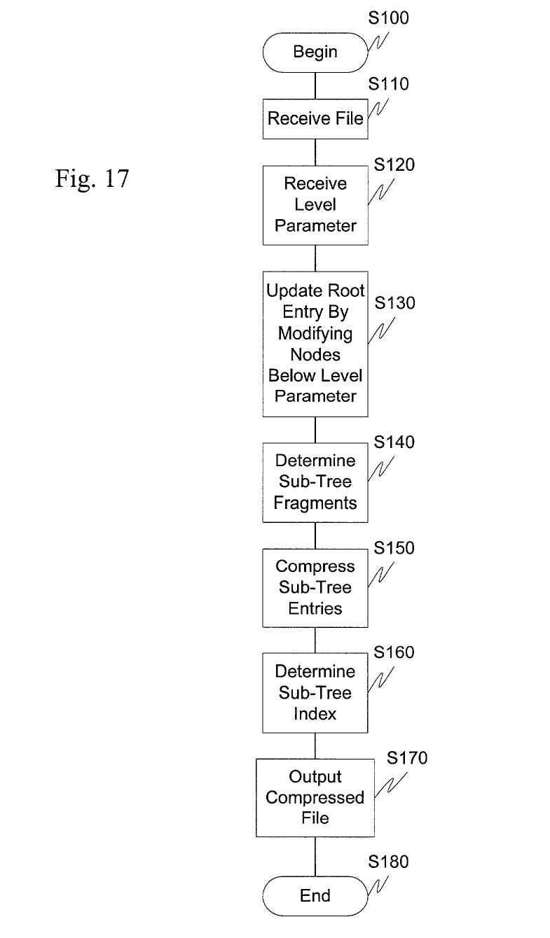

FIG. 17 illustrates a method for compressing a file according to this invention. In particular, control begins in step S100 and continues to step S110. In step S110, a file is received. Next, in step S120, a LEVEL parameter is received, for example, from a user. Then, in step S130 the document tree prefix or root is modified by replacing children below the specified LEVEL parameter with a reference to the associated compressed sub-tree. Control then continues to step S140.

In step S140, the sub-tree fragments below the specified level parameter are identified, and in step S150 compressed. Next, in step S160 a sub-tree index is determined. Then, in step S170, the compressed file can be output. Control then continues to step S180 where the control sequence ends.

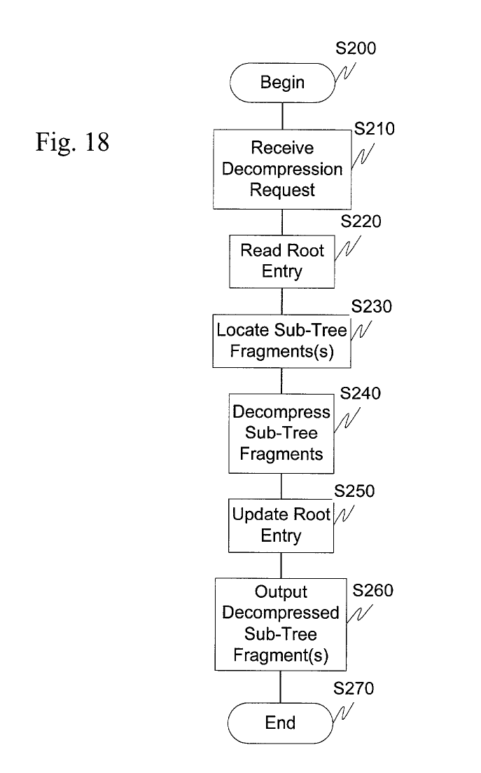

FIG. 18 illustrates an exemplary method of decompressing a file according to an exemplary embodiment of this invention. In particular, control begins in step S200 and continues to step S210. In step S210, based on a data request, a file is received for decompression. Next, in step S220, the document tree prefix that contains the hierarchical relationship of the compressed document is read. Next, in step S230, a requested sub-tree fragment(s) is located. Then, in step S240, the specific sub-tree fragment is decompressed. Control then continues to step S250.

In step S250, the document tree prefix is updated indicating the decompression of the one or more requested fragment(s). Next, in step S260, the decompressed sub-tree fragment is output. Control then continues to step S270 where the control sequence ends.

As illustrated in FIG. 16, the data compression/decompression system and related components can be implemented either on a single programmed general purpose computer or separately programmed general purpose computers. However, the data compression/decompression system can also be implemented in a special purpose computer, a programmed microprocessor or a microcontroller and peripheral integrated circuit element, an ASIC or other integrated circuit, a digital signal processor, a hardwired or electronic logic circuit such as a discrete element circuit, a programmable logic device, such as a PLD, PLA, FPGA, PAL, or the like. In general, any device capable of the flowcharts illustrated in FIGS. 17 and 18 can be used to implement the data compression/decompression system according to this invention.

Furthermore, the disclosed method may be readily implemented in software using object or object-oriented software development environments that provide portable source code that can be used on a variety of computers, workstations and/or software platforms. Alternatively, the disclosed data compression/decompression system may be implemented partially or fully in hardware using standard logic circuits or a VLSI design. Other software or hardware can be used to implement the systems in accordance with this invention depending on the speed and/or efficiency requirements of this system, the particular function, and the particular software and/or hardware systems or microprocessor or microcomputer systems being utilized. The data compression/decompression system illustrated herein, however, can be readily implemented in a hardware and/or software using any known later developed systems or structures, devices and/or software by those of ordinary skill in the applicable art from the functional description provided herein and with a general basic knowledge of the computer and telecommunications arts.

Moreover, the disclosed methods can be readily implemented as software executed on a programmed general purpose computer, a special purpose computer, a microprocessor, or the like. In these instances, the methods and systems of this invention can be implemented as a program embedded in a client or server, such as a web server, plug-in, or the like. The data compression/decompression system can also be implemented by physically incorporating the system and method into a software and/or hardware system, such as a hardware and software system of a browser, server, client computer, or the like.

It is, therefore, apparent that there has been provided in accordance with the present invention, systems and methods for a data compression/decompression system. While this invention has been described in conjunction with a number of embodiments, it is evident that many alternatives, modifications and variations would be or are apparent to those of ordinary skill in the applicable art. Accordingly, applicants intend to embrace all such alternatives, modifications, equivalents and variations that are within the spirit and the scope of this invention.

What is claimed is:

1. A data compression system comprising:
a level management device that identifies one or more portions of data to be selectively compressed; and
a data compression module that compresses the one or more portions of data.

2. The system of claim 1, further comprising a root module that updates portions of a document tree with pointers to the one or more portions of data.

3. The system of claim 2, wherein the document tree comprises a hierarchical structure of a document.

4. The system of claim 1, further comprising an index module that indexes the one or more portions of compressed data.

5. The system of claim 1, wherein the one or more portions of compressed data can be selectively decompressed.

6. The system of claim 1, wherein when the one or more portions of compressed data are selectively decompressed, one or more portions of other data remain compressed.

7. The system of claim 1, wherein the data compression system allows dynamic access to and updating of a content, a structure and a style of a document.

8. The system of claim 1, wherein the data compression scheme is based on a document object model for at least one of XML and HTML.

9. The system of claim 1, wherein a document comprises the one or more portions of data, an uncompressed document tree prefix, one or more compressed sub-tree fragments and an uncompressed fragment index.

10. The system of claim 1, wherein the level management device reads at least a portion of a hierarchically structured document.

11. A data decompression system comprising:
a level management device that identifies one or more portions of data to be selectively decompressed; and
a data decompression module that decompresses the one or more portions of data.

12. The system of claim 11, further comprising a root module that updates portions of a document tree with pointers to the one or more portions of data.

13. The system of claim 12, wherein the document tree comprises a hierarchical structure of a document.

14. The system of claim 11, further comprising an index module that indexes the one or more portions of data.

15. The system of claim 11, wherein one or more portions of compressed data can be selectively decompressed.

16. The system of claim 11, wherein when the one or more portions of compressed data are selectively decompressed, one or more portions of other data remain compressed.

17. The system of claim 11, wherein the data decompression system allows dynamic access to and updating of a content, a structure and a style of a document.

18. The system of claim 11, wherein the data decompression scheme is based on a document object model for at least one of XML and HTML.

19. The system of claim 11, wherein a document comprises the one or more portions of data, an uncompressed document tree prefix, one or more compressed sub-tree fragments and an uncompressed fragment index.

20. The system of claim 11, wherein the level management device reads at least a portion of a hierarchically structured document.

21. A data compression method comprising:
identifying one or more portions of data to be selectively compressed; and
compressing the one or more portions of data.

22. The method of claim 21, further comprising updating portions of a document tree with pointers to the one or more portions of data.

23. The method of claim 22, wherein the document tree comprises a hierarchical structure of a document.

24. The method of claim 21, further comprising indexing the one or more portions of compressed data.

25. The method of claim 21, wherein the one or more portions of compressed data can be selectively decompressed.

26. The method of claim 21, wherein when the one or more portions of compressed data are selectively decompressed, one or more portions of other data remain compressed.

27. The method of claim 21, further comprising allowing dynamic access to and updating of a content, a structure and a style of a document.

28. The method of claim 21, wherein the data compression scheme is based on a document object model for at least one of XML and HTML.

29. The method of claim 21, wherein a document comprises the one or more portions of data, an uncompressed document tree prefix, one or more compressed sub-tree fragments and an uncompressed fragment index.

30. The method of claim 21, further comprising reading at least a portion of a hierarchically structured document.

31. A data decompression method comprising:
identifying one or more portions of data to be selectively decompressed; and
decompressing the one or more portions of data.

32. The method of claim 31, further comprising updating portions of a document tree with pointers to the one or more portions of data.

33. The method of claim 32, wherein the document tree comprises a hierarchical structure of a document.

34. The method of claim 31, further comprising indexing the one or more portions of data.

35. The method of claim 31, wherein one or more portions of compressed data can be selectively decompressed.

36. The method of claim 31, wherein when the one or more portions of compressed data are selectively decompressed, one or more portions of other data remain compressed.

37. The method of claim 31, further comprising allowing dynamic access to and updating of a content, a structure and a style of a document.

38. The method of claim 31, wherein the data decompression is based on a document object model for at least one of XML and HTML.

39. The method of claim 31, wherein a document comprises the one or more portions of data, an uncompressed document tree prefix, one or more compressed sub-tree fragments and an uncompressed fragment index.

40. The method of claim 31, further comprising reading at least a portion of a hierarchically structured document.

41. An information storage media comprising information that compresses data comprising:
information that identifies one or more portions of data to be selectively compressed; and
information that compresses the one or more portions of data.

42. An information storage media comprising information that decompresses data comprising:
information that identifies one or more portions of data to be selectively decompressed; and
information that decompresses the one or more portions of data.
